(19) United States
(12) Patent Application Publication
(10) Pub. No.: US 2018/0101579 A1
(43) Pub. Date: Apr. 12, 2018

(54) ADAPTING AN APPLICATION BASED ON MOOD AND BIOMETRICS

(71) Applicant: INTERNATIONAL BUSINESS MACHINES CORPORATION, Armonk, NY (US)

(72) Inventors: Peeyush Jaiswal, Boca Raton, FL (US); Priyansh Jaiswal, Boca Raton, FL (US); David Jaramillo, Lake Worth, FL (US); Paul Llamas Virgen, Ciudad Guzman (MX); Annita Tomko, Zapopan (MX)

(21) Appl. No.: 15/848,426

(22) Filed: Dec. 20, 2017

Related U.S. Application Data
(63) Continuation of application No. 15/291,104, filed on Oct. 12, 2016.

(51) Int. Cl. G06F 17/30; G06F 9/44

(52) U.S. Cl. CPC G06F 17/30528; G06F 17/30312; G06F 9/4443

(57) ABSTRACT

A method for modifying an application behavior based on a plurality of user specific data is provided. The method may include receiving a plurality of user specific data. The method may also include storing the received plurality of user specific data in a database. The method may further include determining a user mood based on the stored plurality of user specific data. The method may also include transmitting an action to an application corresponding to the determined user mood.

### BACKGROUND

The present invention relates, generally, to the field of computing, and more particularly to adaptive systems.

In computing, adaptation relates to the process of acquiring information and altering system behavior based on the received information. Catalysts are the factors considered by an adaptive system when determining whether to change behavior. Catalysts may be grouped into three categories: inter-individual differences, intra-individual differences, and environmental differences. Inter-individual differences relate to changes among groups of several users, such as spoken languages. Intra-individual differences relate to changes affecting only a single user, such as user goals. Environmental differences relate to a change in the computing environment, such as a change in network connectivity experienced by a smartphone when a user moves physical location.

### SUMMARY

According to one embodiment, a method for modifying an application behavior based on a plurality of user specific data is provided. The method may include receiving a plurality of user specific data. The method may also include storing the received plurality of user specific data in a database. The method may further include determining a user mood based on the stored plurality of user specific data. The method may also include transmitting an action to an application corresponding to the determined user mood.

According to another embodiment, a computer system for modifying an application behavior based on a plurality of user specific data is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a plurality of user specific data. The method may also include storing the received plurality of user specific data in a database. The method may further include determining a user mood based on the stored plurality of user specific data. The method may also include transmitting an action to an application corresponding to the determined user mood.

According to yet another embodiment, a computer program product for modifying an application behavior based on a plurality of user specific data is provided. The computer program product may include one or more computer-readable storage devices and program instructions stored on at least one of the one or more tangible storage devices, the program instructions executable by a processor. The computer program product may include program instructions to receive a plurality of user specific data. The computer program product may also include program instructions to store the received plurality of user specific data in a database. The computer program product may further include program instructions to determine a user mood based on the stored plurality of user specific data. The computer program product may also include program instructions to transmit an action to an application corresponding to the determined user mood.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a mood adaptation process according to at least one embodiment;

FIG. 3 is a functional block diagram of a mood detection and transmission process according to at least one embodiment;

FIG. 4 is a functional block diagram of a mood information collection process according to at least one embodiment;

FIG. 5 is a block diagram of internal and external components of computers and servers depicted in FIG. 1 according to at least one embodiment;

FIG. 6 depicts a cloud computing environment according to an embodiment of the present invention; and

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention are related to the field of computing, and more particularly to adaptive systems. The following described exemplary embodiments provide a system, method, and program product to, among other things, analyze data related to a user's mood and/or biorhythm to adapt the functioning of an application. Therefore, the present embodiment has the capacity to improve the technical field of adaptive systems by utilizing mood detection technology to affect the performance of an application to suit a particular user's mood and/or biorhythms.

As previously described, adaptation relates to the process of acquiring information and altering system behavior based on the received information. Catalysts are the factors considered by an adaptive system when determining whether to change behavior. Catalysts may be grouped into three categories: inter-individual differences, intra-individual differences, and environmental differences. Inter-individual differences relate to changes among groups of several users, such as spoken languages. Intra-individual differences relate to changes affecting only a single user, such as user goals. Environmental differences relate to a change in the computing environment, such as a change in network connectivity experienced by a smartphone when a user moves physical location.

Mood detection technology is software capable of gathering biometric data and using the gathered data to determine a user's mood. For example, a wearable fitness tracker may be capable of determining a user's heart rate and the amount of perspiration on the user's skin to determine that the user is stressed. However, mood detection technology may not be capable of adapting user device behavior when a particular mood is detected. As such, it may be advantageous to, among other things, implement a system that adapts device and/or application performance to the particular mood which a user is currently experiencing.

According to one embodiment, mood and/or biorhythm data may be consistently gathered by sensors on a user device, such as a smartphone or wearable technology. The gathered data may be stored within a database and analyzed to determine the user's particular mood. Thereafter, other devices and/or applications may be notified of the user's mood and device and/or application behaviors may be modified according to the corresponding mood in order to conform to the user's current mood or attempt to change the user's mood. For example, a music application may suggest mood-based content consistent with the user's current mood. Similarly, location-based applications may display suggested products to the user that may improve the user's mood or may be more marketable to the user during the user's current mood.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to modify device and application behaviors according to a user's mood as determined by gathered mood and biorhythmic data.

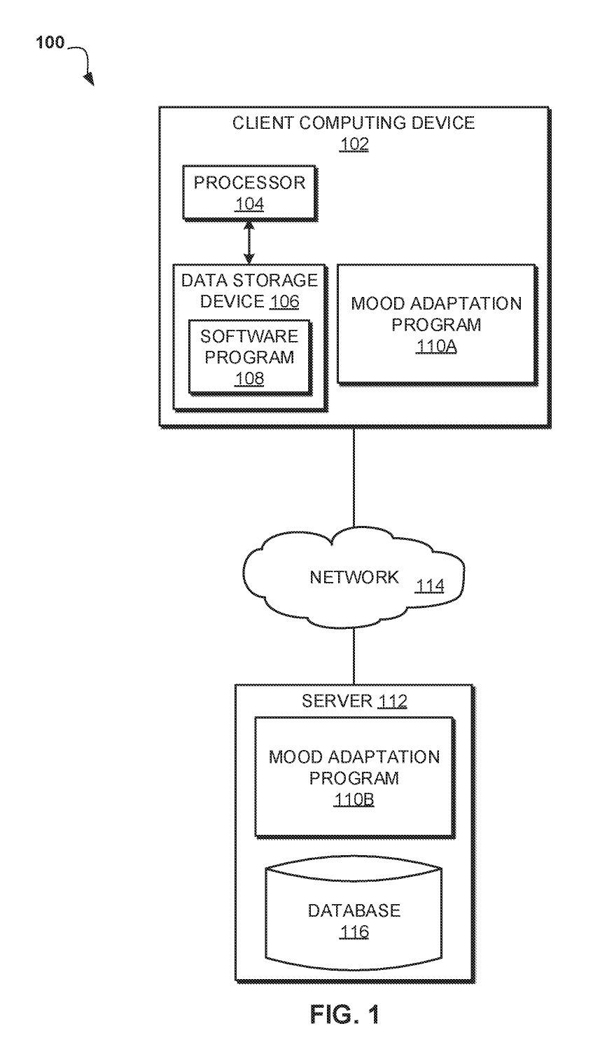

Referring to FIG. 1, an exemplary networked computer environment 100 is depicted, according to at least one embodiment. The networked computer environment 100 may include a client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

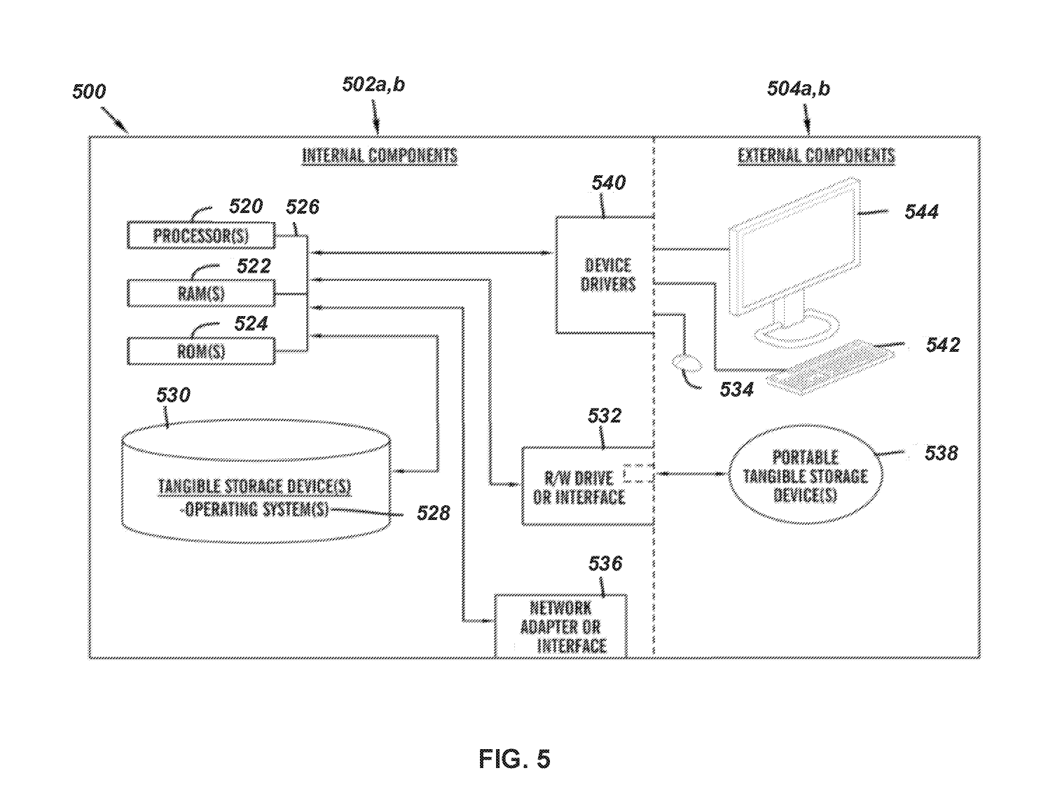

The client computing device 102 may include a processor 104 and a data storage device 106 that is enabled to host and run a software program 108 and a mood adaptation program 110A and communicate with the server 112 via the communication network 114, in accordance with one embodiment of the invention. The client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 5, the client computing device 102 may include internal components 502a and external components 504a, respectively.

The server computer 112 may be a laptop computer, netbook computer, personal computer (PC), a desktop computer, or any programmable electronic device or any network of programmable electronic devices capable of hosting and running a mood adaptation program 110B and a database 116 and communicating with the client computing device 102 via the communication network 114, in accordance with embodiments of the invention. As will be discussed with reference to FIG. 5, the server computer 112 may include internal components 502b and external components 504b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

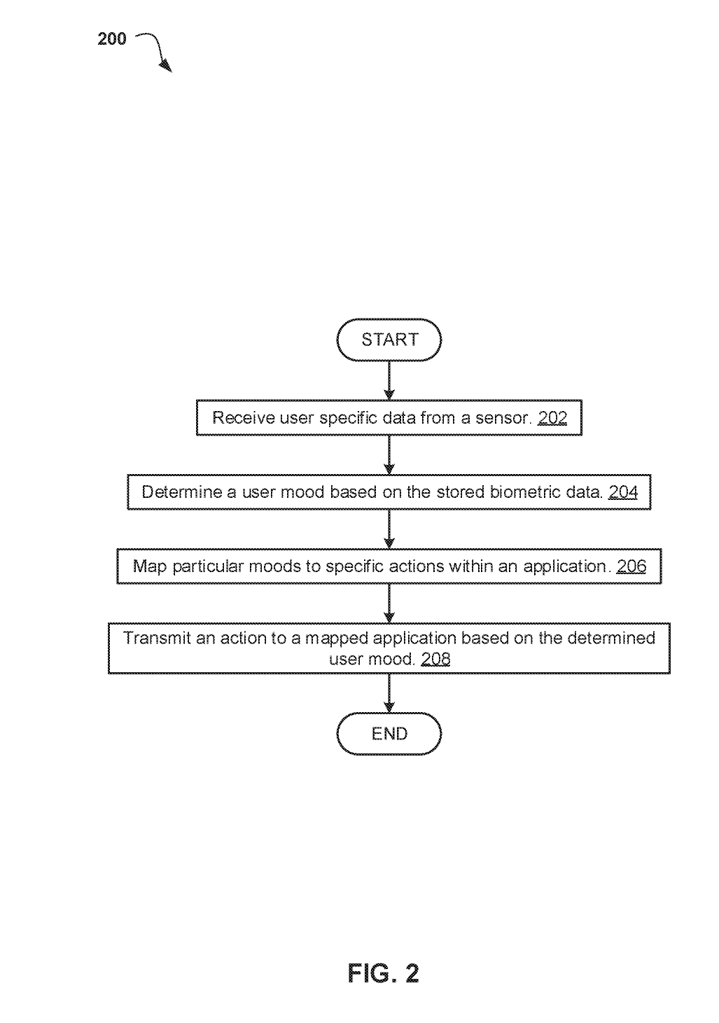

According to the present embodiment, the mood adaptation program 110A, 110B may be a program capable of analyzing biometric data to determine a user's mood and notify mapped applications and devices of the determined mood. When gathering biometric data, the mood adaptation program 110A, 110B may store the gathered biometric data within the database 116. The gathered biometric data may include captured speech and vocal tones, facial scans, locational data, heartbeat, perspiration level, body temperature, and skin pH level. The mood adaptation method is explained in further detail below with respect to FIGS. 2-4.

Referring now to FIG. 2, an operational flowchart illustrating a mood adaptation process 200 is depicted, according to at least one embodiment. At 202, the mood adaptation program 110A, 110B receives user specific data. Using internally imbedded or externally attached sensors, the mood adaptation program 110A, 110B may receive constant signals of data specific to a user, such as biometric data. As previously described, biometric data may include captured speech and vocal tones, facial scans, locational data, heartbeat, perspiration level, body temperature, and skin pH level. In at least one embodiment, the user specific data may also include user interaction data, such as screen pressure on a user device touchscreen, text analysis of user-entered text, button pressure on user device buttons, and user-input text speed. Additionally, the mood adaptation program 110A, 110B may store the biometric data and the user interaction data in a data repository, such as database 116. Furthermore, the database 116 may be a configurable database where the mood adaptation program 110A, 110B and various mood definition characteristics may be user configurable or adjusted based on machine learning of user actions associating applications with specific moods. For example, the mood adaptation program 110A, 110B may determine a user only listens to a fast-paced music playlist when running. Therefore, when the mood adaptation program 110A, 110B detects the user's heartrate, perspiration levels, and travel speed reach a threshold, the mood adaptation program 110A, 110B may play an appropriate fast paced playlist in a music application on the user's smartphone. Furthermore, the user specific data may include environmental data, such as noise level surrounding the user, current weather, humidity, season, time of day, day of year, and month of year.

Then, at 204, the mood adaptation program 110A, 110B determines a user mood based on the stored user specific data. Using the biometric data and user interaction data, the mood adaptation program 110A, 110B may implement known mood detection technology to determine the user's current mood. For example, the mood adaptation program 110A, 110B installed in a smartphone may analyze the stored data to determine a user is driving 50 miles per hour on a highway far from the user's home location with a raised heartrate. Using known mood detection technology, the mood adaptation program 110A, 110B may determine the user is stressed and anxious based on the biometric data and user interaction data.

In at least one embodiment, the mood adaptation program 110A, 110B may map a connection to a user specific database, such as a user calendar, and associate a specific mood with a particular event within the user specific database. For example, if the mood adaptation program 110A, 110B determines a user is experience nervousness just before a particular meeting on the user's calendar, the mood adaptation program 110A, 110B may predict the user will experience the same mood when the same or a similar event is upcoming on the user's calendar and instruct an application and/or device to perform an appropriate action based on the predicted user mood.

Next, at 206, the mood adaptation program 110A, 110B maps particular moods to specific actions within an application. In order for the mood adaptation program 110A, 110B to adequately modify the performance of an application or device based on the user's mood, the mood adaptation program 110A, 110B may map between the mood adaptation program 110A, 110B and a particular application or device. The mapping may be a connection between a specific action that is to be performed by the application or device when the mood adaptation program 110A, 110B determines the user is experiencing a particular mood. For example, if the mood adaptation program 110A, 110B determines the user is feeling sad based on the user specific data, the mood adaptation program 110A, 110B may notify a video streaming application to present a funny video to the user. Additionally, information relating to the mapping between moods and actions may be stored within a data repository, such as database 116. In at least one embodiment, applications and devices may register for certain user moods based on the functionality of the application. For example, when the mood adaptation program 110A, 110B determines the user mood is homesickness, a picture of the user's family may be displayed on the device display screen by a picture sharing application. However, the picture sharing application may not be registered to take any actions if the determined user mood is happiness.

Then, at 208, the mood adaptation program 110A, 110B transmits an action to a mapped application based on the determined user mood. Once the mood adaptation program 110A, 110B determines the appropriate action to perform based on the mapping stored within the database 116, the mood adaptation program 110A, 110B may transmit the action to the appropriate application or device for execution. For example, as previously described, the mood adaptation program 110A, 110B may instruct location-based applications to display suggested products to the user that may improve the user's mood or may be more marketable to the user during the user's current mood.

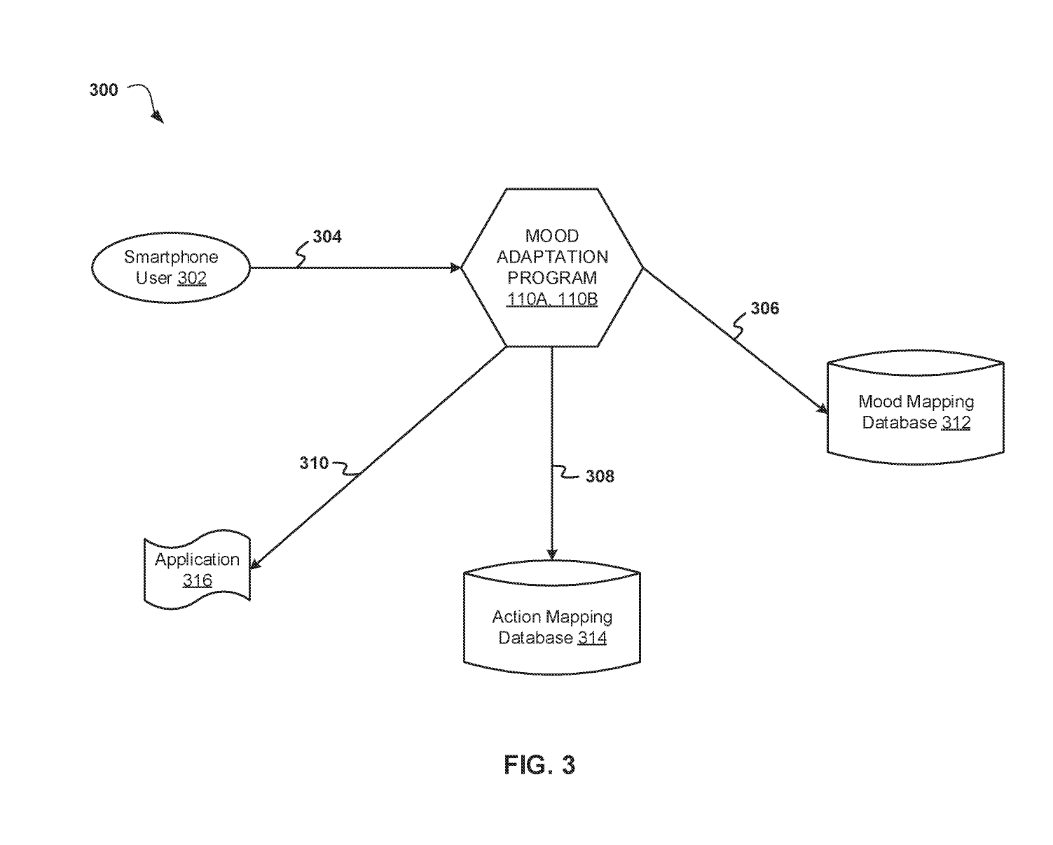

Referring now to FIG. 3, a functional block diagram of a mood detection and transmission process 300 is depicted, according to at least one embodiment. At 304, as previously described in step 202, the mood adaptation program 110A, 110B gathers a constant signal feed of user specific data from a smartphone user 302. As previously described, the user specific data may be user biometric data, user interaction data, and environmental data. The mood adaptation program 110A, 110B uses the gathered user specific data to determine the current user mood, as previously described in step 204. Then, at 306, as previously described in step 206, the mood adaptation program 110A, 110B analyzes a data repository, such as mood mapping database 312, to determine which applications and devices are registered for the determined mood. Mood mapping database 312 may be substantially similar to database 116. Next, at 308, the mood adaptation program 110A, 110B may analyze the action mapping database 314 to determine what actions are to be performed in response to determining the particular user mood. For example, if the mood adaptation program 110A, 110B determines the user is sad, the mood adaptation program 110A, 110B may analyze the action mapping database 314 to determine that a particular song playlist should be played on a music application when the user is sad. Then, at 310, the mood adaptation program 110A, 110B may perform the determined actions in the corresponding applications and/or devices 316. For example, if the playlist in the previous example will be played in a music application, the mood adaptation program 110A, 110B may transmit a command to open the music application (e.g. application 316) and begin playing the first song on the playlist.

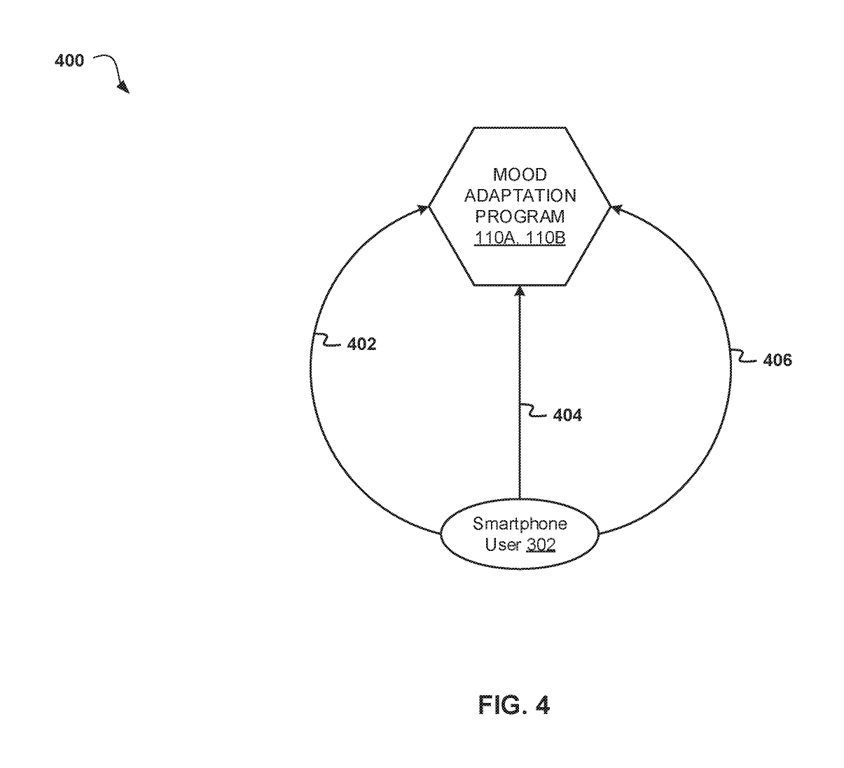

Referring now to FIG. 4, a functional block diagram of a mood information collection process 400 is depicted, according to at least one embodiment. As previously described in step 202, the mood adaptation program 110A, 110B may gather various types of user specific data. At 402, the mood adaptation program 110A, 110B may use an imbedded or externally-attached microphone on a user device to capture speech inflection and tone that can be analyzed by known mood detection technology. At 404, the mood adaptation program 110A, 110B may use known photographic capture technology to analyze facial expressions and environmental factors, such as lighting and current weather. At 406, the mood adaptation program 110A, 110B may utilize locational data, such as current geographic location, relational distance to other individuals, and current traveling speed captured by known locational technologies, such as a global positioning system within a user device. By supplementing the user specific data with the voice data collected by an imbedded or externally-attached microphone, facial expression data captured by photographic technology, and locational data gathered by locational technologies, the user mood may be more accurately determined in step 204.

It may be appreciated that FIGS. 2-4 provide only an illustration of one implementation and do not imply any limitations with regard to how different embodiments may be implemented. Many modifications to the depicted environments may be made based on design and implementation requirements. For example, the mood adaptation program 110A, 110B may establish a mapping with a user calendar to determine specific events that caused a user to previously exhibit a specific mood. Thereafter, the mood adaptation program 110A, 110B may predict the user's future mood for an upcoming event that caused the user to previously experience a specific mood, such as nervousness. The mood adaptation program 110A, 110B may display content according to that previously experienced mood, such as calming classical music.

FIG. 5 is a block diagram 500 of internal and external components of the client computing device 102 and the server 112 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 502a,b and external components 504a,b illustrated in FIG. 5. Each of the sets of internal components 502 include one or more processors 520, one or more computer-readable RAMs 522, and one or more computer-readable ROMs 524 on one or more buses 526, and one or more operating systems 528 and one or more computer-readable tangible storage devices 530. The one or more operating systems 528, the software program 108 and the mood adaptation program 110A in the client computing device 102, and the mood adaptation program 110B in the server 112 are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory, or any other computer-readable tangible storage device that can store a computer program and digital information.

Each set of internal components 502a,b also includes a R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the mood adaptation program 110A, 110B, can be stored on one or more of the respective portable computer-readable tangible storage devices 538, read via the respective R/W drive or interface 532, and loaded into the respective hard drive 530.

Each set of internal components 502a,b also includes network adapters or interfaces 536 such as a TCP/IP adapter cards, wireless Wi-Fi interface cards, or 3G or 4G wireless interface cards or other wired or wireless communication links. The software program 108 and the mood adaptation program 110A in the client computing device 102 and the mood adaptation program 110B in the server 112 can be downloaded to the client computing device 102 and the server 112 from an external computer via a network (for example, the Internet, a local area network or other, wide area network) and respective network adapters or interfaces 536. From the network adapters or interfaces 536, the software program 108 and the mood adaptation program 110A in the client computing device 102 and the mood adaptation program 110B in the server 112 are loaded into the respective hard drive 530. The network may comprise copper wires, optical fibers, wireless transmission, routers, firewalls, switches, gateway computers and/or edge servers.

Each of the sets of external components 504a,b can include a computer display monitor 544, a keyboard 542, and a computer mouse 534. External components 504a,b can also include touch screens, virtual keyboards, touch pads, pointing devices, and other human interface devices. Each of the sets of internal components 502a,b also includes device drivers 540 to interface to computer display monitor 544, keyboard 542, and computer mouse 534. The device drivers 540, R/W drive or interface 532, and network adapter or interface 536 comprise hardware and software (stored in storage device 530 and/or ROM 524).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

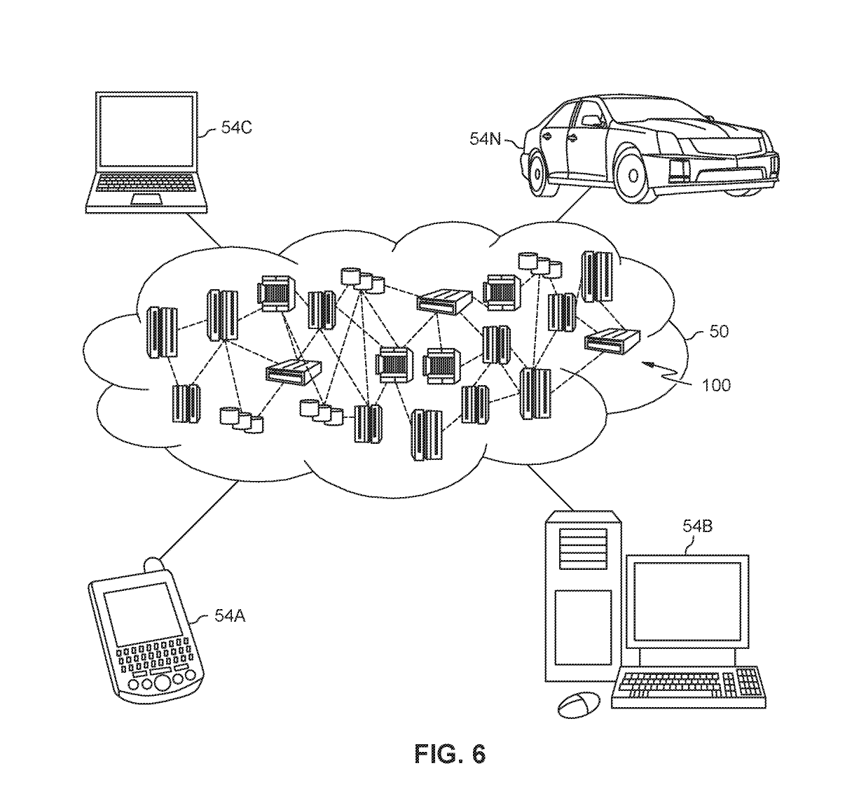

Referring now to FIG. 6, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 100 and cloud computing environment 50 can communicate with any type of computerized device over any type of network and/or network addressable connection (e.g., using a web browser).

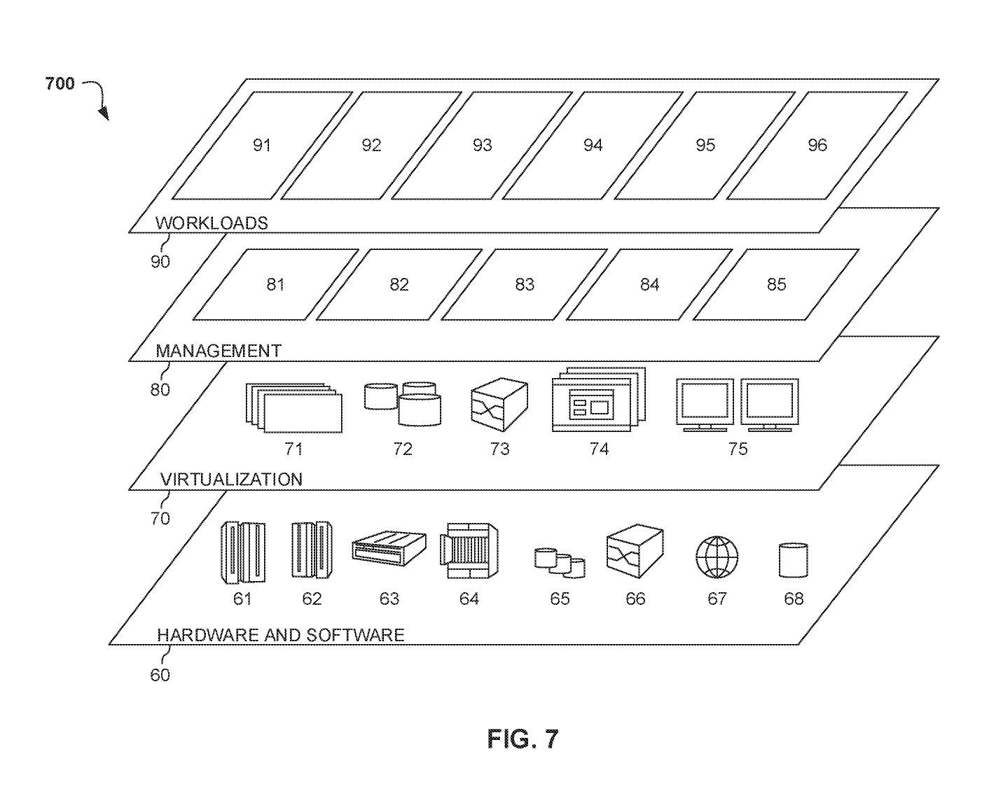

Referring now to FIG. 7, a set of functional abstraction layers 700 provided by cloud computing environment 50 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mood adaptation 96. Mood adaptation 96 may relate to determining a user mood based on collected biometric data and notifying mapped applications and devices to modify behavior according to the determined user mood.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for modifying an application behavior based on a plurality of user specific data, the method comprising:
gathering, by a processor, a plurality of user specific data by one or more sensors on a user device, wherein the user devices is a smartphone or a wearable technology wristband, and wherein the plurality of user specific data relates to identifying a current user mood;
storing the received plurality of user specific data in a database, wherein the database is configurable based on machine learning of one or more user actions associating one or more applications with one or more user moods;
mapping a sad mood with an instruction to execute a music playing application to play a user preconfigured music playlist of one or more uplifting songs to a user;
determining a user is in a sad mood based on the stored plurality of user specific data; and
transmitting the instruction to the music application to play the user preconfigured music playlist.
